(19) United States
(12) Patent Application Publication
(10) Pub. No.: US 2026/0278901 A1
(43) Pub. Date: Sep. 17, 2026

(54) GENERATING TEXT-TO-MOTION ANIMATIONS FROM PARTIALLY ANNOTATED DATASETS

(71) Applicant: Snap Inc., Santa Monica, CA (US)

(72) Inventors: Karl Bayer, Brooklyn, NY (US); Gurunandan Krishnan Gorumkonda, Kirkland, WA (US); Mingdian Liu, Ames, IA (US); Bing Zhou, Rye, NY (US)

(21) Appl. No.: 19/677,880

(22) Filed: May 14, 2026

Related U.S. Application Data
(63) Continuation of application No. 18/433,000, filed on Feb. 5, 2024, now Pat. No. 12,664,713.

(51) Int. Cl. G06T 13/40; G06N 3/0455

(52) U.S. Cl. CPC G06T 13/40; G06N 3/0455

(57) ABSTRACT

A two-stage approach for learning and generating an expressive text-to-motion animation from partially annotated datasets (T2M-X). In an example implementation, T2M-X builds a unified motion dataset based on partially annotated datasets. In the first stage, T2M-X uses the unified motion dataset to train three vector-quantized variational autoencoders (VQ-VAE) for body, hand, and face, respectively, and generate high-quality motion outputs. In the second stage, T2M-X uses the high-quality motion outputs to train a multi-indexing generative pre-trained transformer (GPT) model that includes motion consistency loss and sequence length consistency for learning and then generating coordinated and expressive animations.

### CROSS-REFERENCE TO RELATED APPLICATIONS

This application is a Continuation of U.S. application Ser. No. 18/433,000 filed on Feb. 5, 2024, the contents of which is incorporated fully herein by reference.

### TECHNICAL FIELD

Examples set forth in the present disclosure relate to machine learning, generative models, and training datasets. More particularly, but not by way of limitation, the present disclosure describes building a unified motion dataset based on partially annotated datasets, using the unified motion dataset to train a set of variational autoencoders (VAE) to generate high-quality motion outputs, and using the motion outputs to train a GPT model to generate coordinated and expressive whole-body animations.

### BACKGROUND

Machine learning refers to mathematical models or algorithms that improve incrementally through experience. By processing a large number of different input datasets, a machine-learning algorithm can develop improved generalizations about particular datasets, and then use those generalizations to produce an accurate output or solution when processing a new dataset. Broadly speaking, a machine-learning algorithm includes one or more parameters that will adjust or change in response to new experiences, thereby improving the algorithm incrementally; a process similar to learning.

Text-to-motion refers to the task of generating a movement (e.g., the animation of an avatar, a Bitmoji, a virtual character, the motion of a robot) in response to a text input, such as characters typed on a keyboard and input that can be converted to text (e.g., acronyms, spoken audio, representative icons such as emoji). The output motion is expected to perform the text input in a way that comports with the laws of physics and known capabilities (e.g., avatar parameters, human abilities, robot limitations).

Data annotation refers to the process of reviewing a source (e.g., text files, images, video clips, data), detecting certain types of content found in the source, and then associating tags about the content with the source. A tag refers to a label or other identifier that describes the detected content. A source file that includes stored tags is referred to as annotated data. In the context of machine learning, annotated data helps the model learn more efficiently and completely, especially when the stored tags are closely related to the particular machine-learning models being trained.

### BRIEF DESCRIPTION OF THE DRAWINGS

Features of the various implementations disclosed will be readily understood from the following detailed description, in which reference is made to the appended drawing figures. A reference numeral is used with each element in the description and throughout the several views of the drawings. When a plurality of similar elements is present, a single reference numeral may be assigned to like elements, with an added upper- or lower-case letter referring to a specific element. When referring to a non-specific one or more elements the added letter may be omitted.

The various elements shown in the figures are not drawn to scale unless otherwise indicated. The dimensions of the various elements may be enlarged or reduced in the interest of clarity. The several figures depict one or more implementations and are presented by way of example only and should not be construed as limiting. Included in the drawings are the following figures:

FIGS. 1A and 1B are a block diagrams of an example system for generating an animation which includes a motion representation learning stage and a training stage;

FIG. 2 is a flow chart listing the steps in an example method of building a unified motion dataset, generating training datasets, training a GPT model, and generating an animation;

FIG. 3 is a table of data related to partially annotated datasets and a unified motion dataset;

FIG. 4 is a table of data associated with different methods;

FIG. 5 is a block diagram of a sample configuration of a machine adapted to implement the systems and methods described herein;

FIG. 6A is a table of evaluation data;

FIG. 6B is a table of evaluation data associated with modality pairs;

FIG. 7 is a table of data associated with a set of two hyperparameters; and

FIG. 8 is a table of data associated with a set of three hyperparameters.

### DETAILED DESCRIPTION

Examples of improved two-stage learning and generating for an expressive text-to-motion animation from partially annotated datasets are described herein, which are referred to generally as Text-to-Motion-X (T2M-X). In an example implementation, T2M-X builds a unified motion dataset based on partially annotated datasets. In the first stage, T2M-X uses the unified dataset to train three vector-quantized variational autoencoders (VQ-VAE) for body, hand, and face, respectively, and generate high-quality motion outputs. In the second stage, T2M-X uses the high-quality motion outputs to train a multi-indexing generative pre-trained transformer (GPT) model that includes motion consistency loss and sequence length consistency for learning and then generating coordinated and expressive animations.

The following detailed description includes systems, methods, techniques, instruction sequences, and computer program products illustrative of examples set forth in the disclosure. Numerous details and examples are included for the purpose of providing a thorough understanding of the disclosed subject matter and its relevant teachings. Those skilled in the relevant art, however, may understand how to apply the relevant teachings without such details. Aspects of the disclosed subject matter are not limited to the specific devices, systems, and methods described because the relevant teachings can be applied or practiced in a variety of ways. The terminology and nomenclature used herein is for the purpose of describing particular aspects only and is not intended to be limiting. In general, well-known instruction instances, protocols, structures, and techniques are not necessarily shown in detail.

The term “connect,” “connected,” “couple,” and “coupled” as used herein refers to any logical, optical, physical, or electrical connection, including a link or the like by which the electrical or magnetic signals produced or supplied by one system element are imparted to another coupled or connected system element. Unless described otherwise, coupled, or connected elements or devices are not necessarily directly connected to one another and may be separated by intermediate components, elements, or communication media, one or more of which may modify, manipulate, or carry the electrical signals. The term “on” means directly supported by an element or indirectly supported by the element through another element integrated into or supported by the element.

Additional objects, advantages and novel features of the examples will be set forth in part in the following description, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

Reference now is made in detail to the examples illustrated in the accompanying drawings and discussed below.

In general, a vector-quantized variational autoencoder (VQ-VAE) is a type of machine-learning model that has an artificial neural network architecture. Autoencoders are applied in many contexts, including facial recognition and feature detection. Autoencoders are also used as generative models which can generate new training datasets. A VAE includes an input (x), an encoder, a code or codebook (written to a latent space using variables or vectors), a decoder, and an output (x-prime). The encoder maps the input data to the codebook in the latent space. The decoder receives samples from the latent space and uses the codebook to reconstruct the data and generate the output. The output can be used for a variety of purposes, including the generation of training datasets suitable for training other machine-learning models.

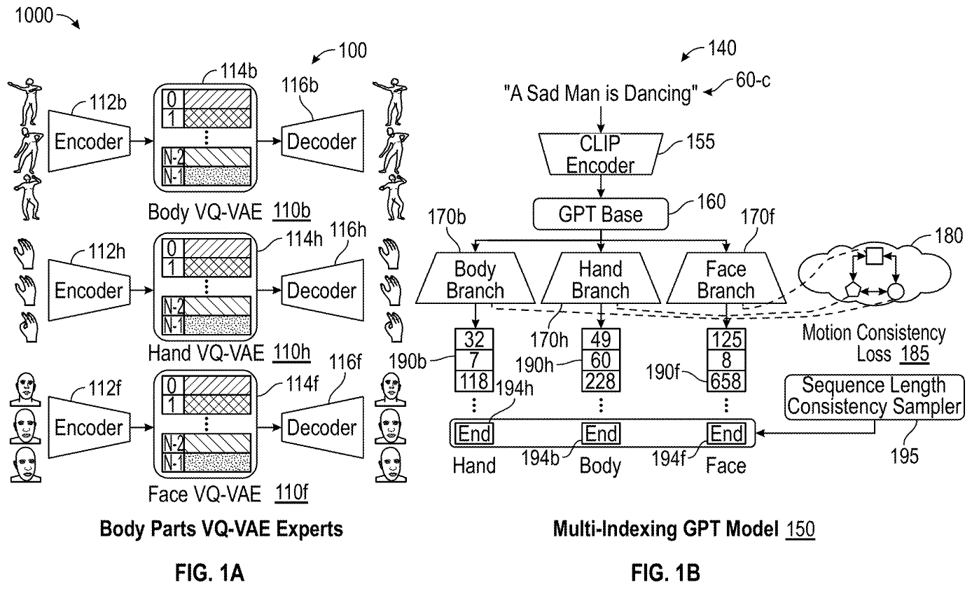

FIGS. 1A and 1B are block diagrams of an example system 1000 for generating an animation which includes a motion representation learning stage 100 and a training stage 140.

The two-stage system 1000 transforms a text input into an expressive whole-body dataset in a standard format (e.g., SMPL-X). As shown in FIG. 1A, the learning stage 100 includes three vector-quantized variational autoencoders (VQ-VAE), each decoding a different body part movement (e.g., body, hand, face) into index sequences. The training stage 140 includes a multi-indexing GPT model 150 that predicts whole-body motion sequences from a text input, which the VAE decoders then convert into motion data. To ensure consistency across the motion modalities (e.g., body, hand, face), a motion consistency loss function is utilized during training.

The motion representation learning stage 100 in some implementations includes three vector-quantized variational autoencoders (VQ-VAE): a body VAE 110b, a hand VAE 110h, and a face VAE 110f. In general, a reference numeral that includes an added letter “b” refers to body elements, “h” refers to hand elements, and “f” refers to face elements.

The body VAE 110b in some implementations includes a body encoder 112b, a body codebook 114b, and a body decoder 116b.

The hand VAE 110h in some implementations includes a hand encoder 112h, a hand codebook 114h, and a hand decoder 116h.

The face VAE 110f in some implementations includes a face encoder 112f, a face codebook 114f, and a face decoder 116f.

Because most of the available datasets are partially annotated, as described herein, the learning stage 100 includes a separate VQ-VAE expert model for each of the three modalities (e.g., body, hand, face). The models 110b, 110h, 110f are trained on high-quality motion datasets (e.g., a unified dataset 320 as described herein) and each model projects the original data into a codebook 114b, 114h, 114f in sparse representation. For example, a series of human motion data can be presented as:

$${M}^{p} ∈ {ℝ}^{T \times {d}_{m}^{p}} ,$$

where M^{p} represents the partial motion data for body (p=1), hand (p=2), and face (p=3), T represents a number of frames, and

$${d}_{m}^{p}$$

represents a data dimension of the motion modality.

The learning stage 100 in some implementations leverages the encoder-decoder of several one-dimensional convolutional layers to compress the whole motion dataset for each modality into a learnable codebook:

$${C}^{p} ∈ {ℝ}^{{K}^{p} \times {d}_{c}^{p}} ,$$

where K^{p} and

$${d}_{c}^{p}$$

represent the length and dimension of the codebook and p represents the modality index (e.g., 1 for body, 2 for hand, 3 for face).

As for the partial motion data M^{p} for each modality, the latent vector extracted from the encoder is denoted as:

$${z}^{p} ∈ {ℝ}^{{T}^{′} \times {d}_{c}^{p}} ,$$

where T-prime equals T divided by l (where l represents the down-sampling rate of the encoder in the temporal domain,) and where

$${d}_{c}^{p}$$

represents the vector dimension (e.g., the same as that of the codebook).

Each VAE in some implementations is vector quantized. To quantize the i-th latent vector zᵢ, a closest vector in the codebook can be represented by the following Equation 1:

$${\hat{z}}_{i}^{p} = arg {min}_{{c}_{k}^{p} ∈ {C}^{p}} {‖ {z}_{i}^{p} - {c}_{k}^{p} ‖}_{2} ∈ {ℝ}^{{d}_{c}^{p}} \qquad ( 1 )$$

and the index of the vector in the codebook is recorded as the motion token:

$${t}_{m , i}^{p} ∈ {ℝ}^{1} .$$

In general, the motion M^{p} is projected into z^{p} by the encoder, quantized as \hat{z}^{p} by the codebook, and also represented by the motion token

$${t}_{m}^{p} .$$

In this aspect, referring again to FIG. 1A, the body VAE 110b generates a quantized body motion vector 120b (\hat{z}¹), the hand VAE 110h generates a quantized hand gesture vector 120h (\hat{z}²), and the face VAE 110f generates a quantized face expression vector 120f (\hat{z}³). Each quantized vector 120b, 120h, 120f can also be represented by its corresponding motion token

$${t}_{m}^{p} .$$

The quantized vector \hat{z}^{p} will be used by the decoder, which operates with an architecture opposite that of the encoder, to reconstruct the motion data \hat{M}^{p} and the motion token

$${t}_{m}^{p}$$

will be fed into the multi-indexing GPT model 150 for model training, as described herein.

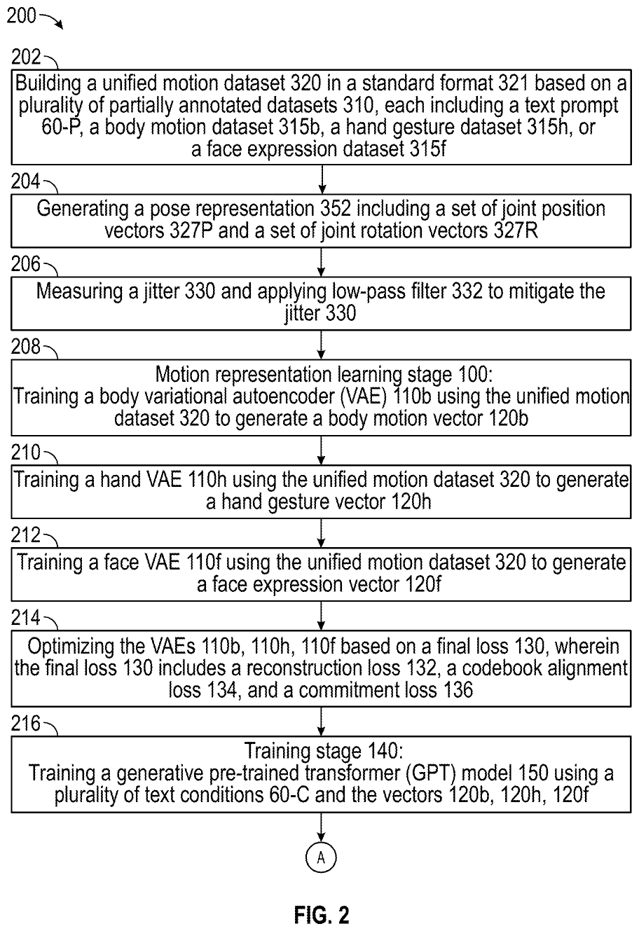

The learning stage 100 and motion vectors 120 are described in FIG. 2 in the context of example method steps.

FIG. 2 is a flow chart 200 listing the steps in an example method of generating an animation. Although the steps are described in the context of training VAE expert models and training a GPT model, other uses and implementations of the steps described, for other types of system, will be understood by one of skill in the art from the description herein. One or more of the steps shown and described may be performed simultaneously, in a series, in an order other than shown and described, or in conjunction with additional steps. Some steps may be omitted or, in some applications, repeated.

Block 202 in FIG. 2 recites an example step of building a unified motion dataset 320 as described herein.

Block 204 in FIG. 2 recites an example step of generating a pose representation 352 that includes a set of joint position vectors 327P and a set of joint rotation vectors 327R. The pose representation 352 in some implementations is generated during the building of the unified motion dataset 320 (block 202) as described herein. The pose representation 352 is useful in addressing motion jitter during the animating process, as described herein. Motion jitter may be produced when using lower-quality datasets.

Block 206 in FIG. 2 recites an example step of measuring a jitter 330 in the motion data (e.g., across the set of GPT codebooks 190, as described herein) by quantifying one or more high-frequency components; and then applying a low-pass filter 332 to mitigate those components. In most instances, a motion jitter in a root joint influences all body joint positions, but the local joint rotations are unaffected by propagated error. Another example step of the process includes generating a pose representation 325 having six degrees of freedom, which incorporates both SMPL-X joint rotations and joint positions. The GPT model 150 predicts both rotations and positions during inference.

Block 208 recites an example step of training a body VAE 110b using the unified motion dataset 320 to generate a body motion vector 120b. Block 210 recites an example step of training a hand VAE 110h using the unified motion dataset 320 to generate a hand gesture vector 120h. Block 212 recites an example step of training a face VAE 110b using the unified motion dataset 320 to generate a face expression vector 120f.

Block 214 recites an example step of optimizing the VAEs 110b, 110h, 110f based on a final loss 130. The motion representation learning stage 100 in some implementations includes a process for optimizing the VAE models 110b, 110h, 110f based on a final loss 130. In some implementations, the final loss 130 includes a standard reconstruction loss 132 associated with the data reconstruction described herein, a codebook alignment loss 134 to update the codebook vector, and a commitment loss 136 to penalize the gap between the output vector from the encoder and the closest vector in the codebook.

The final loss 130 can be expressed using the following equation 2:

$${ℒ}_{vq}^{p} = {ℒ}_{r e}^{p} + {‖ sg [ {z}^{p} ] - {\hat{z}}^{p} ‖}_{2} + β {‖ {z}^{p} - sg [ {\hat{z}}^{p} ] ‖}_{2} \qquad ( 2 )$$

where beta (β) represents a hyper-parameter associated with the commitment loss 136 and where sg is the symbol for the stop-gradient operator. The reconstruction loss 132 in some implementations includes a smooth L1 loss for all the motion modalities and an additional loss related to the body motion velocity V (M^{p}) in order to mitigate jitter, as described herein. The reconstruction loss 132 can be expressed using the following equation 3:

$${ℒ}_{r e}^{p} = {‖ {M}^{p} - {\hat{M}}^{p} ‖}_{1} + α ‖ V ( {M}^{p} ) - V ( {\hat{M}}^{p} ) ‖ \qquad ( 3 )$$

where alpha (α) represents a parameter associated with the additional loss. In some implementations, the value of alpha (α) is set at 0.5 for body motion, zero for hand motion, and zero for face motion.

Referring to FIG. 1B, the training stage 140 in some implementations includes a multi-indexing generative pre-trained transformer (GPT) model 150.

Block 216 in FIG. 2 recites an example step of training the GPT model 150 using a plurality of text conditions 60-C and the quantized motion vectors 120b, 120h, 120f. In some implementations, the training stage 140 starts with training the GPT model 150.

Block 218 in FIG. 2 recites an example step of constructing the GPT model 150 so that it includes, in some implementations, a text encoder 155 (for processing each text condition 60-C), a GPT base 160, and a set of three GPT branches 170. In one aspect, the base and branch architecture enables a partial back-propagation across the GPT model 150.

The GPT branches 170 in some implementations include a body GPT branch 170b, a hand GPT branch 170h, and a face GPT branch 170f. As shown in FIG. 1B, the body GPT branch 170b includes a GPT body codebook 190b and a body stop token 194b. The hand GPT branch 170h includes a GPT hand codebook 190h and a hand stop token 194h. The face GPT branch 170f includes a GPT face codebook 190f and a face stop token 194f.

The GPT model 150 in some implementations includes a single joint space 180, a body motion consistency loss 185, and a sequence length consistency sampler 195 as described herein.

Block 220 in FIG. 2 recites an example step of generating a concatenated text 155-C for each of a plurality of text conditions 60-C. The concatenated text 155-C in some implementations includes previous motion tokens, as described herein.

Block 222 in FIG. 2 recites an example step of calculating a GPT loss 154 based on a length of motion token T, a number of classes N, and hyperparameters, as described in the equations below.

The GPT base 160 in some implementations processes the concatenated text 155-C while the GPT branches 170 predict the next motion token 196 for each of the three modalities. Block 224 in FIG. 2 recites an example step of generating a GPT body codebook 190b, a GPT hand codebook 190h, and a GPT face codebook 190f. In some implementations, the GPT body codebook 190b includes a next body motion token 196b, the GPT hand codebook 190h includes a next hand gesture token 196h, and the GPT face codebook 190f includes a next face expression token 196f. In this aspect, the GPT model 150 functions simultaneously as a generator and a coordinator of the token indices in the VAE expert models 110, a feature referred to herein as multi-indexing.

Block 226 in FIG. 2 recites an example step of estimating, in the single joint space 180, a body motion consistency loss 185.

Block 228 in FIG. 2 recites an example step of imposing a sequence length consistency sampler 195 across the GPT codebooks 190, as described herein.

Block 234 in FIG. 2 recites an example step of generating an animation 199 based on the GPT codebooks 190 and a text input 60-N. In the context of the GPT model 150, the process of submitting a new text input 60-N and generating an animation 199 can be referred to as an inference. The process of generating an animation 199 in some implementations includes building a wireframe model of a character body (e.g., positions and rotations of joints, limbs, features) and then rendering the character around the wireframe in accordance with related parameters. The output data produced by the GPT model 150 is useful in a variety of applications and processes for generating an animation 199 in response to a text input. Generating an animation 199 as described herein includes, for example, animating the motion of an avatar, a Bitmoji, an icon, a virtual character, a robot, and a variety of other elements.

In some implementations, the GPT model 150 conditions the future or next motion on the previous body motion. Previous motion tokens are part of the example step described at block 220. For example, given a text condition 60-C and a set of three token sequences (also referred to herein as vectors 120, including the body motion vector 120b (\hat{z}¹), the hand gesture vector 120h (\hat{z}²), and the face expression vector 120f (\hat{z}³), the GPT model 150 is trained to align the predicted probability distribution:

$${\hat{P}}_{t}^{p} = P ( {\hat{z}}_{t}^{p} \vert c , {\hat{z}}_{1}^{1} , … , {\hat{z}}_{t - 1}^{1} )$$

to the ground truth distribution for body, hand, and face motions. In some implementations, the GPT model 150 adds a special “End” stop token 194 to the end of the motion tokens to indicate the end of a particular motion.

In some implementations, the GPT model 150 includes calculating a GPT loss 154 (block 222 of FIG. 2). The GPT loss function 154 (L_{GPT}) includes three cross-entropy losses and can be expressed using the following equation 4:

$${ℒ}_{GPT} = \frac{1}{T + 1} {\sum }_{t = 1}^{T + 1} {\sum }_{n = 1}^{{N}_{1} + 1} [ - {P}_{tn}^{1} log {\hat{P}}_{tn}^{1} ] + {η}_{1} \cdot \frac{1}{T + 1} {\sum }_{t = 1}^{T + 1} {\sum }_{n = 1}^{{N}_{2} + 1} [ - {P}_{tn}^{2} log {\hat{P}}_{tn}^{2} ] + {η}_{2} \cdot \frac{1}{T + 1} {\sum }_{t = 1}^{T + 1} {\sum }_{n = 1}^{{N}_{3} + 1} [ - {P}_{tn}^{3} log {\hat{P}}_{tn}^{3} ] \qquad ( 4 )$$

where T represents a length of motion token, N represents the number of classes for the motion tokens, and the eta values (η₁ and η₂) represent hyperparameters for adjusting the loss weight related to hand motion and facial expression, respectively. In some implementations, η₁ represents a hand hyperparameter 155h for adjusting a hand loss weight 156h associated with the hand motion, and η₂ represents a face hyperparameter 155f for adjusting a face loss weight 156f associated with the face expression. Block 222 in FIG. 2 recites an example step of calculating a GPT loss 154 based on a length of motion token T, a number of classes N, a hand hyperparameter 155h for adjusting a hand loss weight 156h associated with the hand motion, and a face hyperparameter 155f for adjusting a face loss weight 156f.

In some implementations, the text encoder 155 (e.g., a CLIP encoder) generates a concatenated text 155-C. Referring again to FIG. 2, block 220 recites an example step of generating a concatenated text 155-C using the text encoder 155 (e.g., a CLIP encoder). In some implementations the concatenated text 155-C includes the text condition 60-C along with a set of previous motion tokens 192 (e.g., a previous body motion token 192b, a previous hand gesture token 192h, and a previous face expression token 192f). The previous motion tokens 192 are added to the text embedding to predict the future motions.

In order to leverage the token relevance that was learned in the body VAE 110b, the token embedding from the fixed codebook is input to the GPT base 160 as previous body motion tokens. In a related aspect, the concatenated text embedding and the motion embedding are fed into transformer layers for feature extraction. Because the multi-indexing GPT model 150 operates in an auto-regressive manner, the causal self-attention is utilized in the transformer layer to establish the computational dependency among sequential elements of data The self-attention formula can be expressed using the following equation 5:

$$Attention ( Q , K , V ) = Softmax ( \frac{{QK}^{T} \times M}{\sqrt{{d}_{k}}} ) V \qquad ( 5 )$$

where Q, K, V denote the query, key, and value, respectively, from the input data. M represents a causal mask, which only allows the previous motion data tokens to be used when computing the next or current state of the motion tokens. The extracted feature from the GPT base 160 is fed into the GPT branches 170 to generate the next motion tokens 196. The GPT branches 170 share the same configuration for transformer lawyers as the GPT base 160 except a linear layer is attached to the GPT branches 170 to enable the calculation of the Softmax function above.

During the model training stage 140, the partially annotated datasets are processed first, in some implementations, to enable effective back-propagation throughout the entire GPT model 150. In some implementations, the training data is organized into batches in a way that ensures that each batch contains at least one sample from each data modality (e.g., body, hand, or face). Two masks are also stored in the batch data to indicate the presence or absence of hand motion and face motion in each data sample. Based on the two masks, an average final loss for each modality can be computed according to equation 7, below. In this aspect, the model weights in all the GPT branches 170 are updated with each batch of data, thereby enhancing the stability of the training process. During the inference stage, the “End” stop tokens 194 may appear earlier in the hand motion or the face motion, compared to the body motion. In order to maintain consistency in sequence length across the different modalities, the GPT model 150 includes a sequence length consistency sampler 195. In some implementations, when a stop token 194 appears prematurely (relative to the other body parts), the sequence length consistency sampler 195 replaces the stop token 194 from a predicted hand/face sequence with a token of the second-highest probability. In this aspect, the complete body motion, hand motion, and facial expression can be generated at the same time, conditioned on the next prompt.

Generating data across multiple modalities (e.g., body, hand, face) represents a form of multi-task learning, in which cross-task relations are adapted into multi-modal generative models through consistency learning. As described herein, the system 1000 addresses the limitations of partially annotated data and uses a generative GPT model 150. The GPT model 150 as described herein includes learning a single joint space 180 specifically for motion data across the three modalities (e.g., body, hand, face) and includes a feature extractor based on the GRU layer (gated recurrent unit) which takes into account the previous motion, which improves sequence data generation.

One of the challenges is ensuring consistency between and among the generated motion tokens for body, hand, and face. The models may not fully capture the joint distribution of all motion types across the entire dataset. To meet this challenge, the GPT model 150 in some implementations includes a single joint space 180 for body motion, hand gestures, and facial expressions, as shown in FIG. 1B. Using a single joint space 180 helps ensure coherence between and among the generated motions. In some implementations, a particular GRU layer is used as a feature extractor for each modality, thereby mapping the motion tokens into corresponding embedding spaces. For processing these tokens, the single joint space 180 applies a one-hot encoding followed by concatenation with the classification probabilities from the GPT branches 170. This approach not only ensures the GRU layer effectively learns the feature mappings across the entire motion sequence, but also enables the back-propagation of the loss in the joint space 180 to the GPT model 150 for weight updating. In general, for a ground truth motion data of T tokens, a consistency loss 185 (block 226 in FIG. 2) can be expressed using the following equation 6:

$${ℒ}_{Consist}^{t} = {λ}_{1} {ℒ}_{cl} ( {e}_{t}^{1} , {e}_{t}^{2} ) + {λ}_{2} {ℒ}_{cl} ( {e}_{t}^{1} , {e}_{t}^{3} ) + {λ}_{3} {ℒ}_{cl} ( {e}_{t}^{2} , {e}_{t}^{3} ) \qquad ( 6 )$$

A final loss can be expressed using the following equation 7:

$${ℒ}_{Final} = {ℒ}_{GPT} + \frac{1}{T + 1} {\sum }_{t = 1}^{T + 1} {ℒ}_{Consist}^{t} \qquad ( 7 )$$

where

$${e}_{t}^{1} , {e}_{t}^{2} , {e}_{t}^{3}$$

represents the features extracted from the GRU layers for body, hand, and face, respectively. L_{CL} represents a contrastive loss. The lambda values λ₁, λ₂, λ₃ represent hyperparameters associated with the modality matching losses.

The GPT model 150 in some implementations includes a process for addressing motion jitter. For example, as described at block 204, above, the example process of building the unified motion dataset 320 includes generating a pose representation 352. Block 206, above, describes the example process of measuring the jitter 330 and applying a filter 332. Block 230 in FIG. 2 recites an example step of selectively animating the upper body 52 using a predicted set of upper-body joint rotations 329U for a smoother outcome. The upper-body joint rotations 329U in some implementations can be estimated based on the pose representation 352, which includes a set of joint position vectors 327P and a set of joint rotation vectors 327R. Similarly, the data in the pose representation 352 is useful in a variety of other animation processes. For example, block 232 in FIG. 2 recites an example step of selectively animating the lower body 54 using the reversed lower body joint rotations 329L and joint positions associated with the legs (e.g., to ensure consistency between foot positions and root translations, thereby also minimizing foot sliding.) In this aspect, the process of mitigating jitter in some implementations is part of generating an animation 199 (block 234).

In the context of text-to-motion computational modeling, the models need to accurately learn and execute a mapping from a linguistic space (e.g., text input) to a motion space. The text-to-motion models are limited by the quality and quantity of available datasets. The existing datasets are partially annotated. As used herein, the term “partially annotated” refers to and includes datasets that include text inputs of varying quality (e.g., short, partial, or incomplete descriptions) and annotations related to one or more modalities (e.g., body, hand, face) but not all three. Models trained with partially annotated datasets produce animations with missing elements (e.g., body motion without any hand gestures, or with expressionless or distorted faces). Recent efforts to extract missing motions, to augment the annotations, or to insert default or approximate annotations have produced low-quality results.

The system 1000 in some implementations uses a number of partially annotated datasets and builds a high-quality unified motion dataset 320 in a standard format 310 (e.g., SMPL-X). Block 202 in FIG. 2 recites an example step of building a unified motion dataset 320 in a standard format 310 based on a plurality of partially annotated datasets 310. Each of the partially annotated datasets 310 generally includes at least one of the following elements: a text prompt 60-P, a body motion dataset 315b with or without body annotations, a hand gesture dataset 315h with or without hand annotations, or a face expression dataset 315f with or without face annotations. This example step is shown first in FIG. 2 because the process of building a unified motion dataset 320 in some implementations is accomplished before the learning stage 100 and the training stage 140. each including at least one of the following elements: a text prompt 60-P, a body motion dataset 315b with or without body annotations, a hand gesture dataset 315h with or without hand annotations, or a face expression dataset 315f with or without face annotations.

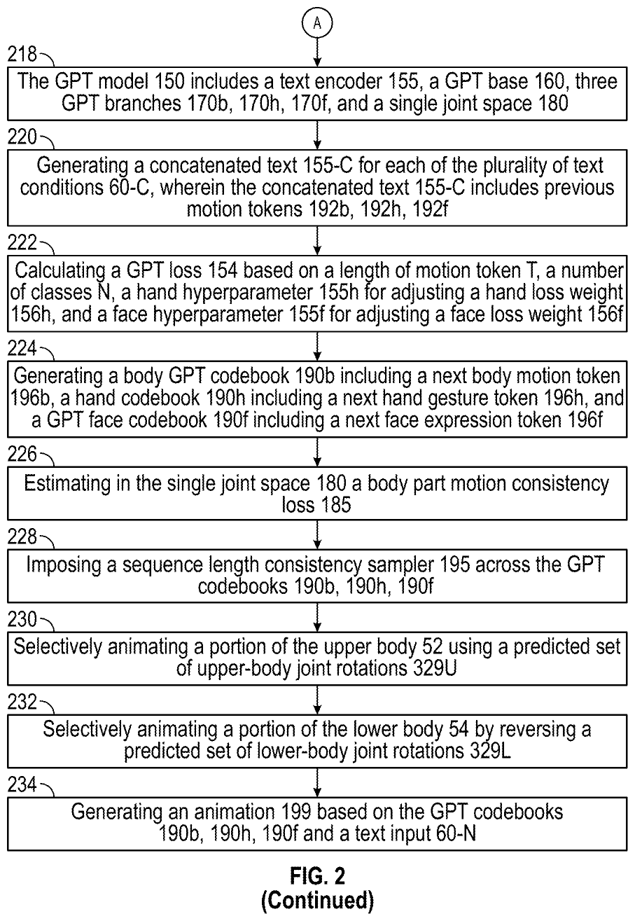

FIG. 3 is a table 300 of statistics related to a number of available datasets 310 that are partially annotated. For example, the HumanML3D dataset included primarily body motion data (e.g., Modality=B for body). The IDEA 400 dataset included some data about all three modalities (BHF for body, hand, and face). Other partially annotated datasets 310 include BAUM, Mixamo, and GRAB.

The annotations in these datasets 310 in some implementations were edited, augmented, labeled, quantified, and otherwise enhanced, and then converted into SMPL-X format, to create a unified motion dataset 320 for use in training the three separate VQ-VAE models 110b, 110h, 110f described herein. For example, the Mixamo dataset included high-quality body or hand motion data and text descriptions; however, the Mixamo dataset included hand pose offsets for a number of default poses that required correction. In some implementations, building the unified motion dataset 320 included establishing a mapping scheme to convert the joint positions in the Mixamo data into SMPL-X format.

In some implementations, building the unified motion dataset 320 included implementing mirror augmentation for all motion data and re-phrasing and augmenting mirror text descriptions.

The GRAB dataset included hand and body movement, but simplistic text descriptions. The simple text descriptions in several datasets 310 were edited and, in some implementations, expanded from a simple label to three or more comprehensive sentences, as described herein. In some implementations, building the unified motion dataset 320 included generating enhanced text descriptions using tools such as ChatGPT and GPT-4. For example, a raw label such as “zombie stumble to the right and fall, zombie stumbling” produces augmented text in the form of a series of sentences: “(1) A person, moving in a zombie-like manner, stumbles to the right and subsequently falls down. (2) Emulating the movements of a zombie, the individual lurches unsteadily towards the right before taking a fall. (3) In a style reminiscent of a zombie, the person staggers to the right and ultimately collapses.”

The combined datasets were converted to a standard format (e.g., SMPL-X) to be consumed in model training. FIG. 3 is a table 300 of the statistics for the unified motion dataset 320. As shown, the unified motion dataset 320 in total includes 61.4K of sequence, 16.6M of frame, 115.3 hours of human motion, and 3.96M text words.

In some implementations, building the unified motion dataset 320 includes generating a pose representation 352 that includes a set of joint position vectors 327P and a set of joint rotation vectors 327R, as described herein with reference to mitigating jitter. Converting all the rotations into 6D rotation vectors produced smoother motion results. In general, a pose representation 352 as used herein is defined as a tuple of (r, b^{p}, b^{v}, v^{r}, c^{f}, h, j, f) where the vector r for a root joint can be expressed as: r∈ [symbol] ⁴ and the local body joint positions, velocities, and rotations in the root joint space can be expressed as:

$${b}^{p} ∈ {ℝ}^{3 \times 21} , {b}^{v} ∈ {ℝ}^{3 \times 21} , and {b}^{r} ∈ {ℝ}^{6 \times 21}$$

The binary features for the foot ground contacts can be expressed as:

$${c}^{f} ∈ {ℝ}^{4} .$$

The hand joint rotations in the wrist joint spaces can be expressed as:

$$h ∈ {ℝ}^{6 \times 30} .$$

The jaw joint rotations related to face motion can be expressed as:

$$j ∈ {ℝ}^{6} .$$

The facial expression feature in SMPL-X format can be expressed as:

$$f ∈ {ℝ}^{50} .$$

Other pose representations, such as that used for the HumanML3D dataset, suffered from rotation information loss in the head and wrist joints, which caused body part rotation artifacts in some cases. The pose representation 352 as described herein animates the upper body using predicted SMPL-X rotations (e.g., to maintain smooth motions) and animates the lower body using reversed rotations from the predicted joint positions (e.g., to minimize foot sliding).

Experiments were conducted on the two-stage text-to-motion-X (T2M-X) system 1000 described herein. According to an example approach, the unified motion dataset 320 was shuffled and split into training (about 80% of the data), validation (about 10%), and test datasets (about 10%). For an example training set, the total motion length was 92.3 hours and it contained 49,100 text descriptions. All motion datasets were downsampled to 30 frames per second. The VAE expert models 110 were trained on different dataset combinations form the unified motion dataset 320.

In some implementations, for the VAE models 110, the settings included a codebook size of 512 by 512 and a downsampling rate of four. An optimizer (e.g., AdamW) with a batch size of 256 and a learning rate of “1e-4” was used to optimize the VAE models 110. A maximum token length of 128 (e.g., 17 seconds for raw motion data) when training the VAE models 110; with a padding strategy. Nine transformer layers were used for the GPT base 160 and for each GPT branch 170, with the hidden dimension of 512 and 16 heads. The weights on hand and face motions were used for next motion prediction. The weights on body-hand matching, body-face matching, and hand-face matching were used for consistency learning. The whole multi-indexing GPT model 150 was optimized with a batch size of 256 by the AdamW optimizer with [β₁, β₂]=[0.5, 0.99] and a typical step learning rate. All models were trained on a single A100 80 GB GPU. According to one example approach, it took approximately 16 hours for the VAE models 110 to reach convergence; and 48 hours for the multi-indexing GPT model 150 to reach convergence.

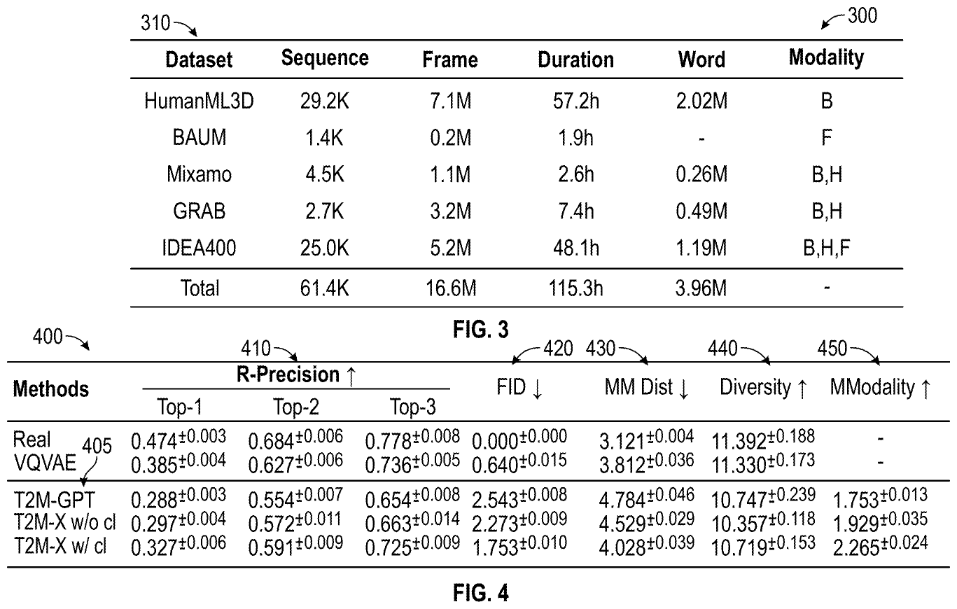

FIG. 4 is a table 400 of data associated with different methods, comparing the system 1000 described herein (“T2M-X”) with other systems. For evaluation purposes, the text descriptions and generated motions were converted to embedding features by the pretrained network in order to calculate several metrics. Frechet Inception Distance (FID) represents the distribution distance between the real and the generated motion on the extracted motion features. Diversity represents the average Euclidean distances of 300 pairs of motion features randomly sampled from a set. Multi-modality (“MModality”) represents the average Euclidean distances of 10 pairs of generated motion features from the same text description. Multi-modal Distance (“MM Dist”) represents the average Euclidean distance between each text feature and the generated motion feature from this text. R-Precision represents the average motion-to-text retrieval accuracy, as ranked by Multi-modal Distance.

The table 400 shown in FIG. 4 includes values associated with the real input data and with the VQ-VAE models 100. The text-to-motion-X (T2M-X) system 1000 described herein was compared to a baseline model 405 known as “T2M-GPT” and a HumanML3D dataset. For comparison, values were obtained for the T2M-X system 1000 without consistency loss (“T2M-X w/o cl”) and with consistency loss (“T2M-X w/cl”). The table 400 includes R-Precision values 410, FID values 420, MM Dist values 430, Diversity values 440, and MModality values 450. The baseline model 405 (“T2M-GPT”) falls short in every category except Diversity, primarily because the HumanML3D dataset is partially annotated for body motion alone.

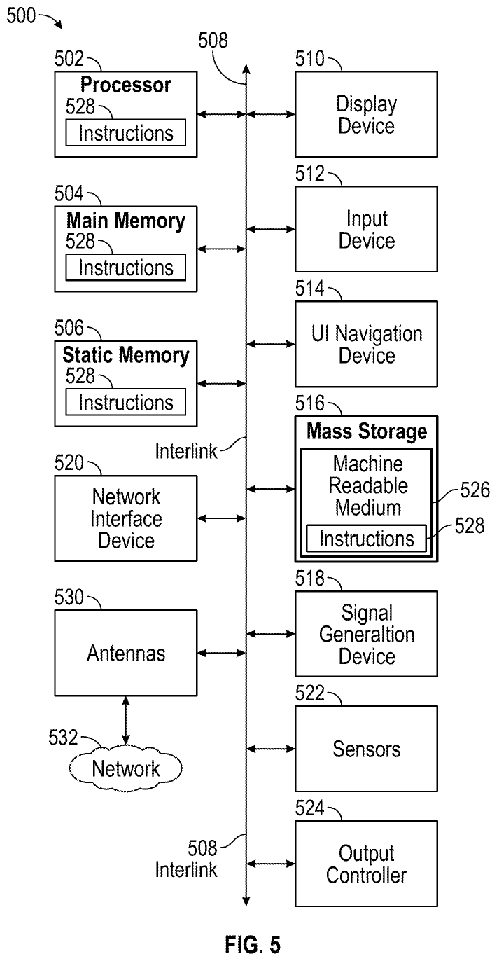

FIG. 5 illustrates an example configuration of a machine 500 including components that may be incorporated into the processor 502 adapted to manage the systems and perform the processes described herein. The techniques described herein may be used with one or more of the computing systems described herein or with one or more other systems. For example, the various procedures described herein may be implemented with hardware or software, or a combination of both. For example, at least one of the processor, memory, storage, output device(s), input device(s), or communication connections discussed below can each be at least a portion of one or more hardware components. Dedicated hardware logic components can be constructed to implement at least a portion of one or more of the techniques described herein. For example, and without limitation, such hardware logic components may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc. Applications that may include the apparatus and systems of various aspects can broadly include a variety of electronic and computing systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computing system. As an example, implementations can include distributed processing, component/object distributed processing, and parallel processing. Moreover, virtual computing system processing can be constructed to implement one or more of the techniques or functionalities, as described herein.

FIG. 5 illustrates a block diagram of an example of a machine 500 upon which one or more configurations may be implemented. In alternative configurations, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. In sample configurations, the machine 500 may be a personal computer (PC), a tablet PC, a set-top box (STB), a personal digital assistant (PDA), a mobile telephone, a smart phone, a web appliance, a server, a network router, switch or bridge, or any machine capable of executing instructions (sequential or otherwise) that specify actions to be taken by that machine. For example, machine 500 may serve as a workstation, a front-end server, or a back-end server of a communication system. Machine 500 may implement the methods described herein by running the software used to implement the features described herein. Further, while only a single machine 500 is illustrated, the term “machine” shall also be taken to include any collection of machines that individually or jointly execute a set (or multiple sets) of instructions to perform any one or more of the methodologies discussed herein.

Examples, as described herein, may include, or may operate on, processors, logic, or a number of components, modules, or mechanisms (herein “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computing systems (e.g., a standalone, client or server computer system) or one or more hardware processors may be configured by firmware or software (e.g., instructions, an application portion, or an application) as a module that operates to perform specified operations. In an example, the software may reside on a machine-readable medium. The software, when executed by the underlying hardware of the module, causes the hardware to perform the specified operations.

Accordingly, the term “module” is understood to encompass at least one of a tangible hardware or software entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computing system or processor) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510 (shown as a video display), an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a mass storage device (e.g., drive unit) 516, a signal generation device 518 (e.g., a speaker), a network interface device 520, and one or more sensors 522. Example sensors 522 include one or more of a global positioning system (GPS) sensor, compass, accelerometer, temperature, light, camera, video camera, sensors of physical states or positions, pressure sensors, fingerprint sensors, retina scanners, or other sensors. The machine 500 may include an output controller 524, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device 516 may include a machine readable medium 526 on which is stored one or more sets of data structures or instructions 528 (e.g., software) embodying or utilized by any one or more of the techniques or functions described herein. The instructions 528 may also reside, completely or at least partially, within the main memory 504, within static memory 506, or within the hardware processor 502 during execution thereof by the machine 500. In an example, one or any combination of the hardware processor 502, the main memory 504, the static memory 506, or the mass storage device 516 may constitute machine readable media.

While the machine readable medium 526 is illustrated as a single medium, the term “machine readable medium” may include a single medium or multiple media (e.g., at least one of a centralized or distributed database, or associated caches and servers) configured to store the one or more instructions 528. The term “machine readable medium” may include any medium that is capable of storing, encoding, or carrying instructions for execution by the machine 500 and that cause the machine 500 to perform any one or more of the techniques of the present disclosure, or that is capable of storing, encoding, or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 528 may further be transmitted or received over communications network 532 using a transmission medium via the network interface device 520. The machine 500 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as WI-FI®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas 530 to connect to the communications network 532. In an example, the network interface device 520 may include a plurality of antennas 530 to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques.

The features and flowcharts described herein can be embodied in one or more methods as method steps or in one or more applications as described previously. According to some configurations, an “application” or “applications” are program(s) that execute functions defined in the programs. Various programming languages can be employed to generate one or more of the applications, structured in a variety of manners, such as object-oriented programming languages (e.g., Objective-C, Java, or C++) or procedural programming languages (e.g., C or assembly language). In a specific example, a third-party application (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application can invoke API calls provided by the operating system to facilitate the functionality described herein. The applications can be stored in any type of computer readable medium or computer storage device and be executed by one or more general purpose computers. In addition, the methods and processes disclosed herein can alternatively be embodied in specialized computer hardware or an application specific integrated circuit (ASIC), field programmable gate array (FPGA) or a complex programmable logic device (CPLD).

Program aspects of the technology may be thought of as “products” or “articles of manufacture” typically in the form of at least one of executable code or associated data that is carried on or embodied in a type of machine-readable medium. For example, programming code could include code for the touch sensor or other functions described herein. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from the server system or host computer of a service provider into the computer platforms of the smartwatch or other portable electronic devices. Thus, another type of media that may bear the programming, media content or metadata files includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to “non-transitory,” “tangible,” or “storage” media, terms such as computer or machine “readable medium” refer to any medium that participates in providing instructions or data to a processor for execution.

Hence, a machine-readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as the main memory of such a computer platform. Tangible transmission media include coaxial cables; copper wire and fiber optics, including the wires that comprise a bus within a computing system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read at least one of programming code or data. Many of these forms of computer readable media may be involved in carrying one or more sequences of one or more instructions to a processor for execution.

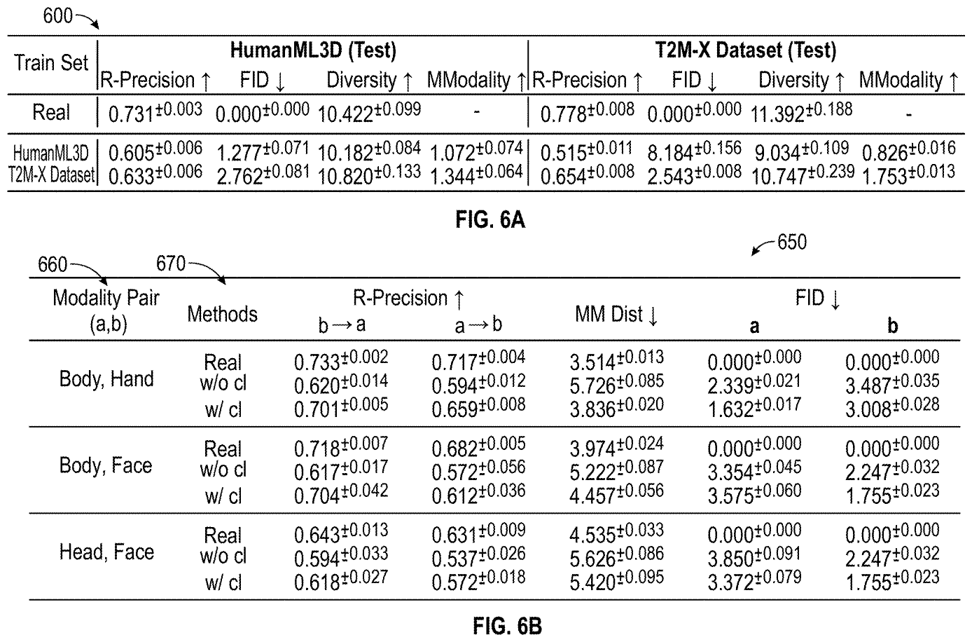

FIG. 6A is a table 600 of data associated with evaluation results using two different datasets: the HumanML3D dataset and the unified motion dataset 320 (“T2M-X Dataset”) described herein. The text-to-motion-X (T2M-X) system 1000 described herein was trained on each of the two datasets, respectively, and compared to the real data. The results for the model as trained on the unified motion dataset 320 (“T2M-X Dataset”) surpasses the results for the model as trained on the HumanML3D dataset (for both test datasets). This result demonstrates that the unified motion dataset 320 performs better because it includes data converted from a variety of other, partially annotated datasets. Qualitative results for the three models (e.g., observing the resulting animations associated with each test dataset) confirmed that the T2M-X system 100 as trained on the unified motion dataset 320 produces superior results.

FIG. 6B is a table 650 of evaluation data associated with a number of modality pairs 660 and methods 670. For evaluating whole-body motion and consistency between and among different body parts, the feature extractor networks were trained on respective dataset combinations for each modality pair 660 (e.g., body, hand; body, face; and hand, face). The results for the T2M-X system 1000 with consistency loss (“w/cl”) demonstrate an improvement in the coherence of the motion of different body parts.

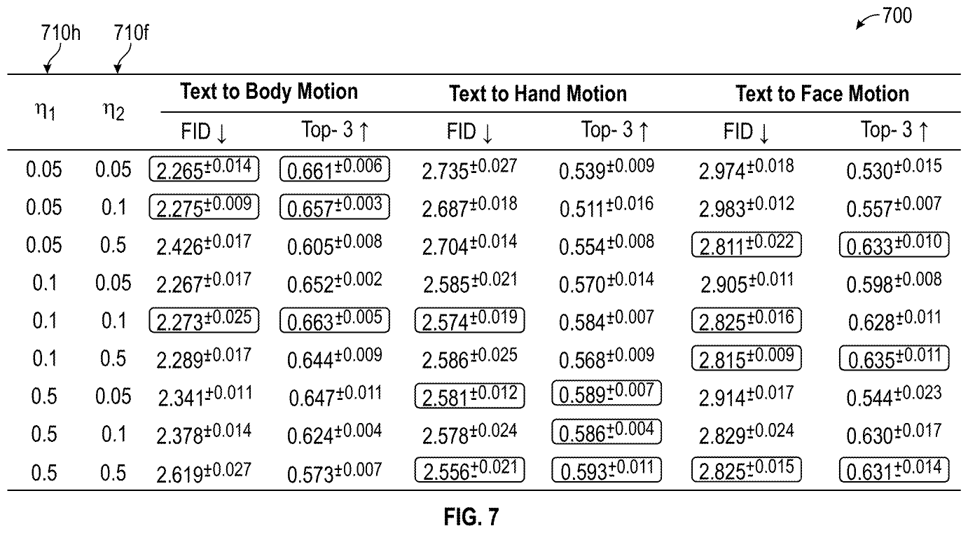

FIG. 7 is a table 700 of data associated with a set of two hyperparameters; specifically, the eta values (η₁ and η₂) which are used by the GPT model 150 to calculate the loss function 154 (L_{GPT}) in equation 4. The eta values (η₁ and η₂) (also referred to as branch weights) are used to adjust the loss weight related to hand motion and facial expression, respectively. In some implementations, η₁ represents a hand hyperparameter 155h for adjusting a hand loss weight 156h associated with the hand motion, and η₂ represents a face hyperparameter 155f for adjusting a face loss weight 156f associated with the face expression. In some implementations, the methods described herein include optimizing the eta values (η₁ and η₂) for peak performance. FIG. 7 shows the results associated with a number of test values 710h for η₁ and a number of test values 710f for η₂. The results indicate peak model performance at η₁=0.1 and η₂=0.1.

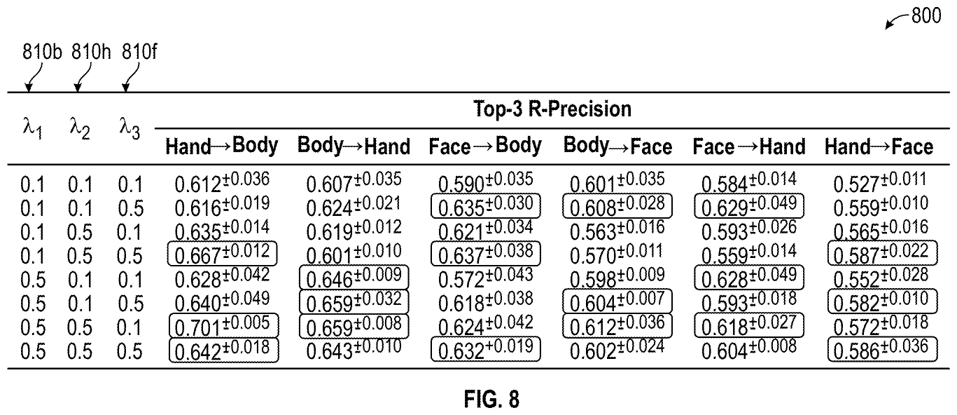

FIG. 8 is a table 800 of data associated with a set of three hyperparameters; specifically, the lambda values λ₁, λ₂, λ₃ which are used to calculate the consistency loss 185 (L_{CONSIST}) in equation 6. In some implementations, the methods described herein include optimizing the lambda values for peak performance. FIG. 8 shows the results associated with a number of test values 810b, 810h, 810f for the lambda values λ₁, λ₂, λ₃, respectively, and the R-Precision values for a number of modality pairs (e.g., hand-body, etc.). The results indicate peak model performance for lambda values of λ₁=0.5, λ₂=0.5, and λ₃=0.1.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A method of generating animations, comprising:
iteratively training a generative pre-trained transformer (GPT) model based on a plurality of text conditions and according to a quantized body motion vector, a quantized hand gesture vector, and a quantized face expression vector;
generating a concatenated text associated with each of the plurality of text conditions using a text encoder, wherein each concatenated text is associated with a set of previous motion tokens;
predicting a series of next motion tokens according to each concatenated text using a set of GPT branches and a single joint space;
generating a set of GPT codebooks according to the series of next motion tokens, wherein the set of GPT codebooks comprises a GPT body codebook, a GPT hand codebook, and a GPT face codebook; and
generating an animation based on the set of GPT codebooks, the series of next motion tokens, and a text input.

2. The method of claim 1, further comprising:
generating a unified motion dataset based on a plurality of partially annotated datasets;
iteratively training a body variational autoencoder (VAE) using the unified motion dataset, wherein the body VAE is operative to generate the quantized body motion vector;
iteratively training a hand VAE using the unified motion dataset, wherein the hand VAE is operative to generate the quantized hand gesture vector; and
iteratively training a face VAE using the unified motion dataset, wherein the face VAE is operative to generate the quantized face expression vector.

3. The method of claim 2, wherein generating the unified motion dataset comprises:
selecting the plurality of partially annotated datasets, wherein each partially annotated dataset comprises one or more of a text prompt, a body motion dataset, a hand gesture dataset, and a face expression dataset; and
building the unified motion dataset in a standard format based on the plurality of partially annotated datasets.

4. The method of claim 2, wherein the body VAE comprises a body encoder, a body codebook, and a body decoder,
wherein the hand VAE comprises a hand encoder, a hand codebook, and a hand decoder,
wherein the face VAE comprises a face encoder, a face codebook, and a face decoder, and
wherein iteratively training each of the body VAE, the hand VAE, and the face VAE comprises optimizing each VAE based on a final loss, wherein the final loss comprises a reconstruction loss, a codebook alignment loss, and a commitment loss.

5. The method of claim 1, wherein the set of previous motion tokens comprises a previous body motion token, a previous hand gesture token, and a previous face expression token, and
wherein the series of next motion tokens is conditioned upon the set of previous motion tokens.

6. The method of claim 1, wherein the set of GPT branches comprises a body GPT branch, a hand GPT branch, and a face GPT branch,
wherein the single joint space is operative to process data associated with the set of GPT branches, and
wherein generating the set of GPT codebooks comprises:
generating the GPT body codebook using the body GPT branch;
generating the GPT hand codebook using the hand GPT branch; and
generating the GPT face codebook using the face GPT branch.

7. The method of claim 1, further comprising:
estimating in the single joint space a body part motion consistency loss, wherein the body part motion consistency loss is based on a contrastive loss and a relative loss value associated with each branch in the set of GPT branches;
imposing a sequence length consistency sampler across the set of GPT codebooks; and
calculating a GPT loss associated with iteratively training the GPT model, wherein the GPT loss comprises three cross-entropy loss values, a weighted hand loss value, and a weighted face loss value.

8. The method of claim 1, wherein the method further comprises generating a unified motion dataset based on a plurality of partially annotated datasets,
wherein iteratively training the GPT model comprises generating a pose representation associated with each record in the unified motion dataset, wherein each pose representation comprises a set of joint position vectors and a set of joint rotation vectors, and
wherein predicting the series of next motion tokens comprises measuring a jitter and applying a low-pass filter to mitigate the jitter.

9. The method of claim 8, wherein generating the animation comprises:
selectively animating an upper body portion using a predicted set of upper-body joint rotations expressed in terms relative to the pose representation; and
selectively animating a lower body portion using a reversed set of lower-body joint rotations expressed in terms relative to the pose representation.

10. A system for generating animations, comprising:
a generative pre-trained transformer (GPT) model iteratively trained based on a plurality of text conditions and according to a quantized body motion vector, a quantized hand gesture vector, and a quantized face expression vector;
a text encoder operative to generate a concatenated text associated with each of the plurality of text conditions, wherein each concatenated text is associated with a set of previous motion tokens;
a set of GPT branches and a single joint space, together operative to predict a series of next motion tokens according to each concatenated text;
a set of GPT codebooks generated according to the series of next motion tokens, wherein the set of GPT codebooks comprises a GPT body codebook, a GPT hand codebook, and a GPT face codebook; and
an animation based on the set of GPT codebooks, the series of next motion tokens, and a text input.

11. The system of claim 10, further comprising:
a unified motion dataset based on a plurality of partially annotated datasets;
a body variational autoencoder (VAE) operative to generate the quantized body motion vector, wherein the body VAE was iteratively trained using the unified motion dataset;
a hand VAE operative to generate the quantized hand gesture vector, wherein the hand VAE was iteratively trained using the unified motion dataset; and
a face VAE operative to generate the quantized face expression vector, wherein the face VAE was iteratively trained using the unified motion dataset.

12. The system of claim 11, wherein the body VAE comprises a body encoder, a body codebook, and a body decoder,
wherein the hand VAE comprises a hand encoder, a hand codebook, and a hand decoder,
wherein the face VAE comprises a face encoder, a face codebook, and a face decoder, and
wherein the system comprises a final loss operative to optimize each VAE during training, wherein the final loss comprises a reconstruction loss, a codebook alignment loss, and a commitment loss.

13. The system of claim 10, wherein the set of GPT branches comprises:
a body GPT branch operative to generate the GPT body codebook,
a hand GPT branch operative to generate the GPT hand codebook, and
a face GPT branch operative to generate the GPT face codebook; and
wherein the single joint space is operative to process data associated with the set of GPT branches.

14. The system of claim 10, further comprising:
a body part motion consistency loss associated with the single joint space, wherein the body part motion consistency loss is based on a contrastive loss and a relative loss value associated with each branch in the set of GPT branches;
a sequence length consistency sampler operative across the set of GPT codebooks;
a GPT loss comprising three cross-entropy loss values, a weighted hand loss value, and a weighted face loss value.

15. The system of claim 10, further comprising:
a unified motion dataset based on a plurality of partially annotated datasets;
a pose representation associated with each record in the unified motion dataset, wherein each pose representation comprises a set of joint position vectors and a set of joint rotation vectors; and
a low-pass filter operative to mitigate an estimated jitter associated with the series of next motion tokens;
a predicted set of upper-body joint rotations expressed in terms relative to the pose representation, wherein the predicted set of upper-body joint rotations is operative to selectively animate an upper body portion; and
a reversed set of lower-body joint rotations expressed in terms relative to the pose representation, wherein the reversed set of lower-body joint rotations is operative to selectively animate a lower body portion.

16. A non-transitory computer-readable medium storing program code which, when executed, is operative to cause an electronic processor to perform functions, including functions to:
iteratively train a generative pre-trained transformer (GPT) model based on a plurality of text conditions and according to a quantized body motion vector, a quantized hand gesture vector, and a quantized face expression vector;
generate a concatenated text associated with each of the plurality of text conditions using a text encoder, wherein each concatenated text is associated with a set of previous motion tokens;
predict a series of next motion tokens according to each concatenated text using a set of GPT branches and a single joint space;
generate a set of GPT codebooks according to the series of next motion tokens, wherein the set of GPT codebooks comprises a GPT body codebook, a GPT hand codebook, and a GPT face codebook; and
generate an animation based on the set of GPT codebooks, the series of next motion tokens, and a text input.

17. The non-transitory computer-readable medium of claim 16, wherein the program code when executed is operative to cause the electronic processor to perform additional functions, including additional functions to:
generate a unified motion dataset based on a plurality of partially annotated datasets, wherein each partially annotated dataset comprises one or more of a text prompt, a body motion dataset, a hand gesture dataset, and a face expression dataset;
build the unified motion dataset in a standard format based on the plurality of partially annotated datasets;
iteratively train a body variational autoencoder (VAE) using the unified motion dataset, wherein the body VAE is operative to generate the quantized body motion vector;
iteratively train a hand VAE using the unified motion dataset, wherein the hand VAE is operative to generate the quantized hand gesture vector;
iteratively train a face VAE using the unified motion dataset, wherein the face VAE is operative to generate the quantized face expression vector; and
optimize each VAE based on a final loss, wherein the final loss comprises a reconstruction loss, a codebook alignment loss, and a commitment loss.

18. The non-transitory computer-readable medium of claim 16, wherein the program code when executed is operative to cause the electronic processor to perform additional functions, including additional functions to:
estimate in the single joint space a body part motion consistency loss, wherein the body part motion consistency loss is based on a contrastive loss and a relative loss value associated with each branch in the set of GPT branches;
impose a sequence length consistency sampler across the set of GPT codebooks; and
calculate a GPT loss associated with iteratively training the GPT model, wherein the GPT loss comprises three cross-entropy loss values, a weighted hand loss value, and a weighted face loss value.

19. The non-transitory computer-readable medium of claim 16, wherein the program code when executed is operative to cause the electronic processor to perform additional functions, including additional functions to:
generate a unified motion dataset based on a plurality of partially annotated datasets,
generate a pose representation associated with each record in the unified motion dataset, wherein each pose representation comprises a set of joint position vectors and a set of joint rotation vectors, and
apply a low-pass filter that is operative to mitigate an estimated jitter associated with the series of next motion tokens.

20. The non-transitory computer-readable medium of claim 19, wherein the program code when executed is operative to cause the electronic processor to perform additional functions, including additional functions to:
selectively animate an upper body portion using a predicted set of upper-body joint rotations expressed in terms relative to the pose representation; and
selectively animate a lower body portion using a reversed set of lower-body joint rotations expressed in terms relative to the pose representation.
